(19) United States
(12) Patent Application Publication
(10) Pub. No.: US 2012/0113670 A1
(43) Pub. Date: May 10, 2012

(54) DEVICE AND METHOD FOR TRANSILLUMINATING A FILM

(75) Inventors: Rudolf Wulf, Riedstadt (DE); Klaus Anderle, Darmstadt (DE); Markus Hasenzahl, Riedstadt (DE)

(73) Assignee: DFT Digital Film Technology Holding GmbH, Weiterstadt (DE)

(21) Appl. No.: 13/264,869

(22) PCT Filed: Apr. 15, 2010
(86) PCT No.: PCT/EP2010/002313

§ 371 Date: Jan. 4, 2012

(30) Foreign Application Priority Data
Apr. 17, 2009 (DE) 10 2009 017 535.0

(51) Int. Cl. G09F 13/04; F21V 7/05; F21V 5/00

(52) U.S. Cl. 362/560; 362/97.4; 362/559

(57) ABSTRACT

A device for transilluminating a film has a light exit emitting with a light beam for transilluminating the film, a transillumination region for guiding the film such that the light beam can transilluminate the film in the transillumination region, a film feed for feeding the film to the transillumination region and a film removal for removing the film from the transillumination region. The device moreover includes a hollow chamber with a diffusely reflecting inner surface and a light entrance opening receiving light from a light source and an exit opening, as well as an optical guide having a beam entrance end and a beam exit end. The beam entrance end is arranged such that light exiting from the exit opening of the hollow chamber at least partially enters through the beam entrance end into the optical guide.

The invention relates to a device and a method for transilluminating a film.

It is known from practical applications to transilluminate films and to further process, for example to record or digitize, the light passing through the film during transillumination. This method is used, for example, for digitizing the film sequence obtained from the sequence of images on the film in order to allow post-processing of the film sequence. Such methods are also used for archiving film material, wherein the light signals produced by the transillumination are converted into electrical signals and these electrical signals are stored, optionally after digitalization. The transillumination of a film also makes it possible to read out the audio signal applied on the film in optical form by transilluminating the optical reproduction of the audio signal and converting the resulting light signal into an audio signal by suitable means. Transillumination of a film can also be used to identify the position of the film. For identifying the position of the film, for example, perforation holes or other reference markings of the film can be used, if present. In practical applications, different methods are known for determining the position of a film in an apparatus by transilluminating the perforation holes.

An apparatus for transilluminating a film with a light exit, from which a light beam exits with which the film can be transilluminated, is known from DE 200 12 748 U1. In the apparatus described therein, a transillumination region is provided through which the film can be guided, so that the light beam can transilluminate the film in the transillumination region. In this known apparatus, a light source embodied as a halogen lamp is provided, which produces at least one light beam which enters an integration rod having ground side faces and a rectangular cross-section through condenser lenses, heat filters, a filter wheel and a neutral density filter. This integration rod is enclosed by a light-tight housing and has a light exit which is connected with the light entrance face of a cross-section converter, which is connected to the integration rod with a sleeve. The integration rod is embodied as a kaleidoscope rod. It produces a diffuse illumination with a relatively large exit angle. DE 200 12 748 U1 claims that this has the advantage of rendering scratches on the surface of the film face away from the emulsion layer less noticeable.

In view of this background, it is the object of the invention to provide an apparatus for transilluminating a film which has a simple structure and/or produces the least possible stress on the film during transillumination.

This object is attained with the subject matter of the independent claim 1 and the method of claim 15. Advantageous embodiments are recited in the dependent claims and in the following description.

The invention is based on the core concept to employ a hollow sphere having a diffusely reflecting interior surface and a light entrance opening and an exit opening. Light entering the cavity, preferably a hollow sphere, via the light entrance opening is diffusely reflected, so that diffuse light exits from the exit opening. This diffuse light is received according to the apparatus of the invention by an optical guide. In this way, the hollow sphere can be arranged at a location distal from the transillumination region and the diffuse light produced by the hollow sphere can be guided to a desired irradiation location through the optical guide.

The benefits of the invention can also be attained with cavities that are not constructed as a hollow sphere, for example with cavities having an elliptical envelope. To simplify the description of the invention, the invention will hereinafter be described based on the preferred shape of the cavity, namely a hollow sphere, without limiting the described possible embodiment of the invention exclusively to embodiments using a hollow sphere. The core concept of the invention and in particular the embodiments described in detail below can therefore also be implemented with a cavity having a shape other than a hollow sphere.

In a preferred embodiment, the hollow sphere is constructed as a so-called Ulbricht sphere. In a particularly preferred embodiment, the sphere has a diffusely reflecting interior coating and an exit opening arranged on its surface at a right angle with respect to the light entrance opening. A light source emitting light is disposed in front of the light entrance opening, and the light enters the entrance opening. The interior coating is preferably made from a diffusely reflecting material having excellent reflection, for example barium sulfate or Macor. In a particularly preferred embodiment, Spectralon may also be used for the interior coating. With light in the infrared region, gold can also be used as coating of the sandblasted interior surface. The diameter of the light entrance opening and of the exit opening is preferably smaller than the inside diameter of the sphere, so that only light which was previously reflected several times at the interior surface reaches the exit the plane of the exit opening. In a preferred embodiment, the area of all openings together is not greater than 5% of the total surface of the hollow sphere.

In a preferred embodiment, the beam output end of the optical guide is arranged so that the light exiting the beam output end is radiated into the transillumination region for transilluminating a film located in the transillumination region. The beam output end of the optical guide is then the light exit from which the light beam, with which the film is transilluminated in the transillumination region, exits. In this preferred embodiment, the optical guide represents a direct connection between the exit opening and the transillumination region. This results in a simple structure of the apparatus of the invention. Alternatively, additional optical elements, such as lenses, filters, mirrors or other optical guides may be arranged between the beam output end and the transillumination region. By using additional optical means, the light beam exiting from the beam output end can be diverted in another direction, if this is desired due to the spatial layout of the apparatus. Likewise, the light beam exiting from the beam output end may be changed with the optical means, for example through focus adjustments or by filtering out different frequencies.

In a preferred embodiment, the form of the beam input end of the optical guide is matched to the exit opening of the hollow sphere so that the beam input end substantially closes off the exit opening. This increases the efficiency of the apparatus, because substantially the total light exiting from the exit opening is received by the optical guide. Additionally, sealing elements may be provided which seal a possible gap between the outside contour of the beam entrance end and the contour of the exit opening.

In a preferred embodiment, a plate for blocking light beams that enter substantially straight through the light entrance opening is arranged inside the hollow sphere in front of the light entrance opening. This increases the number of reflections with which a light beam is reflected inside the hollow sphere after entering through the light entrance opening before the light beam exits from the exit opening. Such plate also helps to prevent direct illumination from the light entrance opening to the exit opening. The blocking plate may be planar. However, the blocking plate may also be concave or convex. In this way, light beams which radiate substantially straight through the light entrance opening are diverted into a different direction.

In a preferred embodiment, the hollow sphere has a measurement opening. A measurement device can measure characteristic properties of the light in the hollow sphere through this measurement opening, for example sensors can be provided which measure the light intensity in different spectral ranges of the light in the hollow sphere. The information about characteristic properties of the light in the hollow sphere can then be used in the evaluation of the light beams which have transilluminated the film and which are received by a recording unit after transilluminating the film.

In a preferred embodiment, a plate for blocking those light beams is provided inside the hollow sphere in front of the measurement opening, which would in absence of the plate radiate substantially straight through the measurement opening. As a result, the measurement device only measures the diffuse portion of the light in the hollow sphere.

According to another aspect of the invention, an apparatus with a light exit for transilluminating a film is provided, with a light beam exiting the light exit for transilluminating the film in a transillumination region. This apparatus according to the invention has a film feed and a film removal and a housing, wherein the transillumination region is arranged on the outside of the housing. According to this aspect of the invention, a light source producing the light beam exiting the light exit is arranged inside the housing. The light beam is guided through an optical guide at least along a portion of the path between the light source and the transillumination region.

In a preferred embodiment, the housing is rectangular or is comprised of two rectangles arranged on top of one another. In a preferred embodiment, the housing has a base and four exterior side faces. In a preferred embodiment, the housing is designed so that the transillumination region, the film feed and the film removal are arranged on one side. In a preferred embodiment, elements of optionally provided measurement and control components of the apparatus according to the invention are arranged inside the housing. Likewise, an evaluation device, preferably a computer, can be arranged inside the housing for evaluating electrical signals generated by a recording unit provided according to a preferred embodiment, which records a light beam passing through the film in the transillumination region.

With the light source arranged inside the housing, the light source can be thermally insulated from the transillumination region. This prevents the heat produced by the light source from heating the film in the transillumination region. The arrangement of the light source inside the housing according to the invention also allows the light source to be heated by a heater. Heating the light source may aid, depending on the time of the light source, the light source to produce light beams having the same characteristics independent on the ambient condition in which the apparatus according to the invention is located.

According to a preferred embodiment, a door may be provided on the housing which can be moved in front of the transillumination region arranged on the outside of the housing to protect the transillumination region from the environment. Alternatively, double doors may also be used.

In a preferred embodiment, the concept of arranging the light source inside a housing according to the aforementioned aspect of the invention is combined with the aspect of the invention wherein a hollow sphere having an interior surface that is diffusely reflecting and has a light entrance opening and an exit opening is provided with the apparatus of the invention.

According to a preferred embodiment, the optical guide is embodied as a glass rod. Using a glass rod as an optical guide has the advantage that the geometry of the glass rod does not or only insignificantly change when the ambient conditions change. Alternatively, the optical guide may also be constructed from other elements, for example from glass fibers or glass fiber bundles.

In a preferred embodiment, the glass rod has several partial segments, each having a rectangular cross-section, wherein the direction of the lengthwise extent of a partial segment is different from the direction of the lengthwise extent of an adjacent partial segment, and wherein the transition from one partial segment to an adjacent partial segment is formed by an inclined mirror surface, which defects a light beam oriented parallel to the lengthwise extent of the one partial segment so that the light beam is then in the adjacent partial segment oriented parallel to the lengthwise extent of the adjacent partial segment. Use of the glass rod makes it possible to guide the light beam produced by the light source, or the light beam exiting from the exit opening of the hollow sphere, along a path that is different from a straight path. In this way, the light source, or the hollow sphere, may be located at other locations of the apparatus different from those locations that are arranged on a straight line at a distance from the transillumination region. This increases the flexibility in the design of the apparatus according to the invention.

In a preferred embodiment, at least one light emitting diode is provided which produces a light beam that enters the hollow sphere through the light entrance opening. In an alternative embodiment, at least one light emitting diode is provided which produces a light beam that enters in a straight line from the light emitting diode into the beam entrance end of the optical guide, if the apparatus according to the invention is constructed according to a possible embodiment of the second aspect of the invention without a hollow sphere. Using at least one light emitting diode as a light source allows a energy-efficient generation of a light beam.

In a preferred embodiment, a plurality of light emitting diodes is employed, with each light emitting diode producing a blue light beam. Alternatively or in addition, a plurality of light emitting diodes is provided which each produce a red light beam. Alternatively or in addition, a plurality of light emitting diodes is provided which each produce a green light beam. The selection of the color of the light of the light produced by the light source depends on the transillumination task to be performed. The apparatus according to the invention can be used to transilluminate the film with diffuse white light. Alternatively, the apparatus according to the invention can be used to transilluminate the film with light located in only a narrow frequency range of the color spectrum. For example, the apparatus according to the invention may be used to transilluminate the film with infrared light.

In a particular preferred embodiment, the apparatus according to the invention includes light emitting diodes producing a blue light beam, as well as light emitting diodes producing a green light beam as well as light emitting diodes producing a red light beam in a first frequency spectrum of the red region of the color spectrum, and another plurality of light emitting diodes which produce a red light beam in a second frequency range of the red spectrum of the color spectrum. This makes it possible, for example, to transilluminate different film types with the same apparatus, wherein the film types are different in that their dyes are located in the red range at different center wavelengths.

In a preferred embodiment, the apparatus includes a heater which heats one light emitting diode, and particularly preferred all light emitting diodes present, to a predetermined temperature. The frequency or the wavelength of the light beam produced by a light emitting diode may depend on the temperature of the light emitting diode. In this way, differences in the characteristics of the light produced by the light source can occur, depending on the ambient conditions, in particular the ambient temperatures at which the apparatus according to the invention is used. The heater according to the invention can be used to heat the light emitting diodes to a predetermined temperature which can be selected so as not to be exceeded even under particularly extreme ambient conditions, in particular particularly extreme ambient temperatures. For example, the light emitting diode may be heated to temperatures of 70° C. In this way, the apparatus has always the same characteristics independent of the ambient conditions. Alternatively, a cooling system configured to cool the light emitting diodes to a predetermined value may be provided.

In a preferred embodiment, a current controller for the light emitting diodes is provided. This can be used for setting the center wavelengths of the light emitted by the light emitting diodes.

In a preferred embodiment, the apparatus according to the invention and the method according to the invention can be used for scanning a film, in particular for generating electrical, particularly preferred digital signals, which include the optical information recorded on the film.

The invention will now be described with reference to the drawing which shows only an exemplary embodiment. The sole FIGURE shows a schematic side view on an apparatus according to the invention for transilluminating a film.

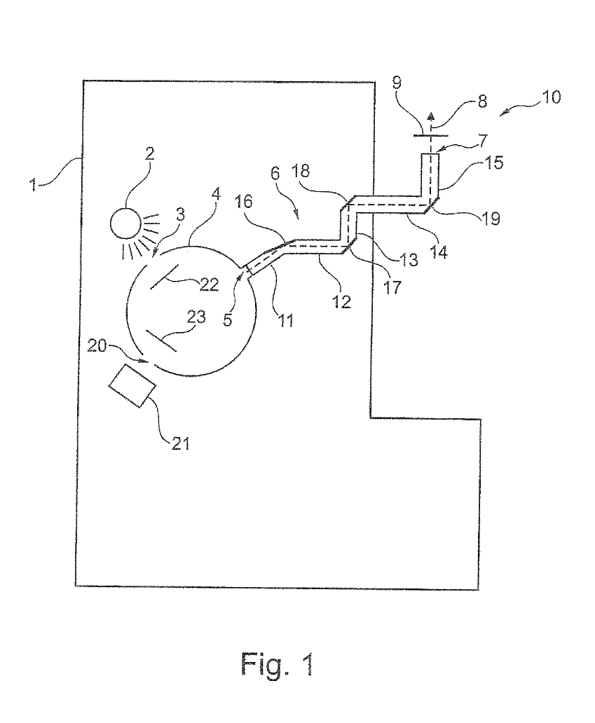

FIG. 1 shows an apparatus for transilluminating a film with a housing 1 formed of two rectangles arranged on top of one another. A light source 2, from which light exits and enters a hollow sphere 4 through a light entrance opening 3, is arranged inside the housing. The hollow sphere 4 has an exit opening 5. Light exiting from the exit opening 5 of the hollow sphere is incident on the beam input end of a glass rod 6. A light beam 8 exits from the beam output end 7 of the glass rod 6 and transilluminates a film 9 in a transillumination region 10.

The glass rod has various partial segments 11, 12, 13, 14 and 15, wherein the direction of the lengthwise extent of a partial segment 11, 12, 13, 14 is different from the direction of the lengthwise extent of the an adjacent partial segment 12, 13, 14, 15 and the transition from a partial segment 11, 12, 13, 14 to an adjacent partial segment 12, 13, 14, 15 is formed by an inclined mirror surface 16, 17, 18, 19, which diverts a light beam oriented parallel to the lengthwise extent of the one partial segment 11, 12, 13, 14 so that the diverted light beam is oriented in the adjacent partial segment 12, 13, 14, 15 parallel to the lengthwise extent of the adjacent partial segment 12, 13, 14, 15.

The hollow sphere 4 has a measurement opening 20. A measurement device 21 is arranged so as to be able to measure through the measurement opening characteristic properties of the light in the hollow sphere.

Inside the hollow sphere 4, a plate 22 is arranged in front of the light entrance opening 3 and a plate 23 is arranged in front of the measurement opening 20 for blocking light beams which have a substantially straight incidence through the light entrance opening 3, or which in absence of the plate 23 would radiate out substantially straight through the measurement opening 20.

What is claimed is:

1-16. (canceled)

17. An apparatus for transilluminating a film, comprising
a transillumination region through which the film is guided,
a film feed for feeding the film to the transillumination region,
a light exit from which a light beam exits, the light beam transilluminating the film in the transillumination region,
a film removal for removing the film from the transillumination region,
a cavity having a light entrance opening and an exit opening and an interior surface constructed to be diffusely reflecting,
a light source producing light entering the cavity through the light entrance opening, and
an optical guide having a beam entrance end and a beam exit end,
wherein the beam entrance end is arranged so that light exiting from the exit opening of the cavity enters into the optical guide at least partially through the beam entrance end.

18. The apparatus of claim 17, wherein the beam exit end of the optical guide is arranged so that a light beam exiting from the beam exit end is incident on the transillumination region so that the film located in the transillumination region is transilluminated.

19. The apparatus of claim 17, wherein a shape of the beam entrance end of the optical guide matches a shape of the exit opening of the cavity such that the beam entrance end substantially closes off the exit opening.

20. The apparatus of claim 17, further comprising a first plate arranged inside the cavity in front of the light entrance opening for blocking light beams that are incident substantially straight through the light entrance opening.

21. The apparatus of claim 17, further comprising a measurement opening disposed in the cavity.

22. The apparatus of claim 21, further comprising a second plate arranged inside the cavity in front of the measurement opening for blocking light beams which without the second plate would radiate out of the cavity substantially straight through the measurement opening.

23. An apparatus for transilluminating a film, comprising:
a transillumination region through which the film is guided,
a film feed for feeding the film to the transillumination region,
a film removal for removing the film from the transillumination region,
a housing, wherein the transillumination region is arranged outside the housing,
a light source arranged inside the housing and producing a light beam exiting from a light exit, and
an optical guide guiding the light beam exiting from the light exit along at least a portion of a path between the light source and the transillumination region, with the guided light beam exiting the optical guide transilluminating the film in the transillumination region.

24. The apparatus of claim 17, wherein the optical guide is a glass rod.

25. The apparatus of claim 23, wherein the optical guide is a glass rod.

26. The apparatus of claim 25, wherein the glass rod comprises individual partial segments each having a rectangular cross-section and a lengthwise extent defining a direction, wherein the direction of an individual partial segment differs from the direction of an adjacent individual partial segment, with transitions between adjacent individual partial segment being formed by an inclined mirror surface which diverts a light beam propagating in the individual partial segments so as to be oriented parallel to the directions of the corresponding individual partial segments.

27. The apparatus of claim 17, wherein the light source comprises at least one light emitting diode.

28. The apparatus of claim 23, wherein the light source comprises at least one light emitting diode.

29. The apparatus of claim 17, wherein the light source comprises:
a plurality of light emitting diodes, with each light emitting diode generating a blue light beam,
a plurality of light emitting diodes, with each light emitting diode generating a red light beam, and
a plurality of light emitting diodes, with each light emitting diode generating a green light beam.

30. The apparatus of claim 23, wherein the light source comprises:
a plurality of light emitting diodes, with each light emitting diode generating a blue light beam,
a plurality of light emitting diodes, with each light emitting diode generating a red light beam, and
a plurality of light emitting diodes, with each light emitting diode generating a green light beam.

31. The apparatus of claim 27, further comprising a heater which heats the at least one light emitting diode.

32. The apparatus of claim 28, further comprising a heater which heats the at least one light emitting diode.

33. The apparatus of claim 27, further comprising a current controller for controlling a current flow through the light emitting diode.

34. The apparatus of claim 28, further comprising a current controller for controlling a current flow through the light emitting diode.

35. A method for transilluminating a film, comprising the steps of:
feeding the film to a transillumination region with a film feed,
guiding the film through the transillumination region for transilluminating the film,
illuminating a light entrance opening of a cavity having an interior surface formed to be diffusely reflecting with a light source,
transmitting light exiting from an exit opening of the cavity at least partially to a beam entrance end of an optical guide,
transilluminating the film with a light beam exiting from a beam exit end of the optical guide, and
removing the film from the transillumination region with a film removal.
